(19) United States
(12) Patent Application Publication
(10) Pub. No.: US 2002/0036623 A1
(43) Pub. Date: Mar. 28, 2002

(54) Information processing apparatus, information inputting device, and information processing main unit

(76) Inventor: Tsuyoshi Kano, Tokyo (JP)

Correspondence Address: COOPER & DUNHAM LLP, 1185 Avenue of the Americas, New York, NY, 10036, US

(21) Appl. No.: 09/872,790

(22) Filed: Jun. 1, 2001

(30) Foreign Application Priority Data
Jun. 6, 2000 (JP) P2000-168480

(51) Int. Cl. G09G 5/00

(52) U.S. Cl. 345/179

(57) ABSTRACT

An information processing apparatus, an information inputting device and an information processing main unit, which enable users to smoothly perform input operations and are more convenient to use. The information processing apparatus comprises a main unit and an input device. A touch panel is attached to a display screen of an LCD of the main unit. The input device includes a tip portion and a rotating wheel rotatable by the user. When the rotating wheel is rotated, information indicating the rotating operation applied to the rotating wheel is transmitted from a transmitter of the input device to the main unit. The main unit includes a receiver for receiving a signal from the input device, and executes information processing in accordance with the signal from the input device or upon contact of the tip portion of the input device against the touch panel.

### BACKGROUND OF THE INVENTION

1. Field of the Invention

The present invention relates to an information processing apparatus, such as a personal information processing apparatus suitable to be carried with users, called a pager or PDA (Personal Digital Assistant).

2. Description of the Related Art

As a system for inputting information to an information processing apparatus such as a pager or PDA, there is known, for example, one using a contact position detector called a touch panel (touch screen). The touch panel is attached to a display screen of a display device, e.g., an LCD (Liquid Crystal Display), of the information processing apparatus.

The touch panel detects a coordinate position on the display screen, against which a user's finger tip, a pen tip or the like is contacted, and determines an input item in accordance with the detected coordinate position. With such a touch panel, a user is able to decide an input item and to input information just by lightly touching the display screen. Therefore, the user can relatively easily perform a complicated input operation such as inputting characters.

In an information processing apparatus of the type inputting information using a touch panel, however, the user is often required to repeat the same operation, for example, when scrolling information displayed on the display screen or when moving from one menu to another in a hierarchical menu. Thus, the user operation is complicated and more expense in effort and time is required to display the target information or menu in some cases.

As shown in FIG. 13, by way of example, in an information processing apparatus 100, such as a pager or PDA, which includes an LCD 101 having a touch panel 102 attached to the overall surface of a display screen, the user must apply pressure to a pressed field for scrolling each time when the screen image is to be scrolled. Further, since the scroll amount per touch is constant, the smooth operation and the smooth scrolling cannot be realized.

More specifically, in FIG. 13A, a downward arrow DW indicates that there is further character information subsequent to the displayed character information. To display the character information subsequent to the displayed character information in this case, the user contacts a pen or the like against a position (i.e., a predetermined pressed field) on the touch panel 102 corresponding to the display position of the downward arrow DW or the vicinity thereof, whereby a next frame of image is displayed as shown in FIG. 13B.

Then, to display character information subsequent to the displayed character information in FIG. 13B, the user must repeat the operation of contacting a pen or the like against the position on the touch panel 102 corresponding to the display position of the downward arrow DW in the display image of FIG. 13B. Let assume a case where the scroll amount per touch is, e.g., one frame of image. In this case, to display character information that is positioned plural frames of image ahead, the user must repeat plural times the operation of contacting a pen or the like against the position on the touch panel 102 corresponding to the display position of the downward arrow DW. Also, when the scroll amount per touch is one frame of image and character information spreads over two frames of image, a screen image is often scrolled downward and upward alternately to read the character information. Thus, such character information is inconvenient to read and the user is required to repeat the similar operation frequently to read it.

Further, when going back to the original frame of image after the target information has been displayed by repeating the operation of contacting a pen or the like against the position on the touch panel 102 corresponding to the display position of the downward arrow DW, the user must now repeat plural times the operation of contacting a pen or the like against the position on the touch panel 102 corresponding to the display position of the upward arrow UP.

Stated otherwise, for example, when the character information to be displayed is a relatively long text, the similar operation must be frequently repeated to display the target character information. Therefore, the user operation is troublesome, and it is often difficult to promptly display the target character information through smooth scrolling.

Moreover, as shown in FIG. 14, when moving one menu to another in a hierarchical menu in the information processing apparatus 100, such as a pager or PDA, which includes the LCD 101 having the touch panel 102 attached to the overall surface of a display screen, the user is required to make troublesome operations and hence the smooth operation is not realized in some cases.

For example, in the case of proceeding to a target lower-level sub-menu after displaying an image of main menu as shown in FIG. 14A, the user can proceed to the lower-level sub-menu, shown in FIG. 14B, by contacting a pen or the like against a position on the touch panel 102 corresponding to the display position of the displayed item representing the target sub-menu.

Then, it is often desired to return to the original main menu (higher-level menu) from the sub-menu of FIG. 14B. In the example shown in FIG. 14, the user can return to the higher-level menu, i.e., the main menu shown in FIG. 14A, by contacting a pen or the like against a position on the touch panel 102 corresponding to the display position of a back icon BK prepared beforehand on the screen image of FIG. 14B.

It has been conventional, as described above, that the user is required to frequently contact against the touch panel attached to the display screen, and to selectively apply pressure to one of a plurality of pressed fields corresponding to different display positions on the display screen for executing the target processing. As a result, the user operation is complicated and the information processing apparatus is inconvenient to use.

### SUMMARY OF THE INVENTION

In view of the state of the art set forth above, an object of the present invention is to overcome the problems with the related art and to provide an information processing apparatus, an information inputting device and an information processing main unit, which enable users to smoothly perform input operations and are more convenient to use.

More specifically, one object of the present invention is to provide an information processing apparatus comprising a main unit section, and an input device section for receiving an operation input from a user and transmitting information indicating the received operation input to the main unit section, the main unit section comprising a display device; a contact position detecting unit provided on a display screen of the display device and detecting a user contact position on the display screen; a receiving unit for receiving a signal transmitted from the input device section; and an information processing unit for executing processing depending upon the contact position on the display screen detected by the contact position detecting unit or in accordance with the signal transmitted from the input device section and received by the receiving unit, the input device section comprising a tip portion brought into contact against the display screen for designating a position on the display screen; a first operating unit capable of being rotated; a rotation detecting unit for detecting a rotating operation applied to the first operating unit and outputting a signal representing the rotating operation; and a transmitting unit for transmitting the signal from the rotation detecting unit to the receiving unit of the main unit section.

With the information processing apparatus set forth above, the apparatus comprises the main unit section and the input device section. When the user contacts the tip portion of the input device section against the contact position detecting unit provided on the display screen of the display device of the main unit section, a coordinate position on the display screen of the display device is detected and an input item can be decided in accordance with the detected coordinate position.

Also, the input device section includes the first operating unit capable of being rotated, and when the first operating unit is rotated, information indicating the rotating operation applied to the first operating unit is transmitted to the main unit section through the transmitting unit of the input device section. The information indicating the rotating operation of the first operating unit and transmitted from the input device section is information about a motion of the first operating unit, specifically information indicating, e.g., the direction and amount of rotation of the first operating unit.

Further, the information processing unit of the main unit section executes information processing, e.g., a process of scrolling information displayed on the display screen, depending upon an input item decided from the coordinate position on the display screen of the display device, which is detected by the contact position detecting unit, or in accordance with the information transmitted from the input device section and received by the receiving unit of the main unit section.

Thus, the user can input information to the main unit section by any of two operations of contacting the tip portion of the input device section against the contact position detecting unit and rotating the first operating unit of the input device section. In other words, it is also possible to input information to the main unit section by applying the rotating operation to the first operating unit. As a result, an information processing apparatus is provided which can realize smooth operations and is more convenient to use.

Another object of the present invention is to provide an information processing apparatus wherein, in the input device section, the first operating unit is capable of being not only rotated but also depressed, and the transmitting unit transmits a signal representing a depression operation applied to the first operating unit.

With the information processing apparatus set forth above, the user can input information to the main unit section by any of three operations of contacting the tip portion of the input device section against the contact position detecting unit, rotating the first operating unit of the input device section, and depressing the first operating unit of the input device section. As a result of further utilizing the depressing operation of the first operating unit, an information processing apparatus is provided which can realize smoother operations and is even more convenient to use.

For example, the rotating operation of the first operating unit of the input device section may be used to select an optional item displayed on the display screen of the display device of the main unit section, and the depressing operation of the first operating unit may be used to decide the optional item that is displayed on the display screen and is in selectable state by the rotating operation of the first operating unit.

Thus, by rotating and depressing the first operating unit of the input device section, the user can select a target item, decide the target item, and start processing corresponding to the decided item in a screen image containing a plurality of optional items, such as a menu image. As a result, an information processing apparatus is provided which can realize smoother operations on the main unit section and is even more convenient to use.

Still another object of the present invention is to provide an information processing apparatus wherein the input device section includes a second operating unit in addition to the first operating unit, and the transmitting unit transmits a signal representing an operation applied to the second operating unit.

With the information processing apparatus set forth above, the second operating unit is provided in the input device section in addition to the first operating unit, and the transmitting unit of the input device section can also transmit information indicating the operation of the second operating unit to the main unit section.

Therefore, the user can further input information to the main unit section by employing the second operating unit of the input device section. As a result, an information processing apparatus is provided which can realize smoother operations and is even more convenient to use.

For example, the rotating operation of the first operating unit of the input device section may be used to select an optional item in, e.g., a hierarchical menu displayed on the display screen of the display device of the main unit section, and the depressing operation of the first operating unit may be used to decide the optional item in the menu, which is in a selectable state by the rotating operation of the first operating unit. Also, the operation of the second operating unit may be used to instruct cancel of a currently displayed screen image.

Thus, by rotating and depressing the first operating unit of the input device section, the user can similarly select a target item, decide the target item, and start processing corresponding to the decided item in a screen image containing a plurality of optional item, such as a menu image.

In addition, the currently displayed screen image can be canceled for return to the original menu image by operating the second operating unit. Therefore, the user can easily move between menu images at different levels in the case of, for example, returning from one menu at a lower level to another at a higher level. As a result, an information processing apparatus is provided which can realize smoother operations on the main unit section and is even more convenient to use.

Still another object of the present invention is to provide an information processing apparatus wherein the main unit section and the input device section are connected to each other through wireless communication.

With the information processing apparatus set forth above, the main unit section and the input device section are connected to each other through wireless communication so that information indicating the rotating operation of the first operating unit, information indicating the depressing operation of the first operating unit, and information indicating the operation of the second operating unit are transmitted from the input unit section to the main unit section by wireless.

As a result, a convenient information processing apparatus can be realized because the user is free from annoyance caused by the presence of a cable connecting the main unit section and the input device section as often experienced in the case where the main unit section and the input device section are interconnected through wire.

Still another object of the present invention is to provide an information inputting device constituted by the input device section in the independent form, and to provide an information processing main unit constituted by the main unit section in the independent form.

### BRIEF DESCRIPTION OF THE DRAWINGS

FIG. 1 is a schematic view for explaining one embodiment of an information processing apparatus according to the present invention;

FIG. 2 is a block diagram for explaining one embodiment of the information processing apparatus according to the present invention;

FIG. 3 is a flowchart for explaining a process of transmitting a signal from an input device in the present invention;

FIG. 4 (A and B) is a representation for explaining a scrolling process carried out in the information processing apparatus according to the present invention;

FIG. 5 is a flowchart for explaining the scrolling process carried out in the information processing apparatus according to the present invention;

FIG. 6 (A, B and C) is a representation for explaining a process of selecting and deciding one of option items from a menu, which is carried out in the information processing apparatus according to the present invention;

FIG. 7 is a flowchart for explaining the process of selecting and deciding one of option items from a menu, which is carried out in the information processing apparatus according to the present invention;

FIG. 8 (A, B and C) is a representation for explaining changes of a screen image displayed in an editing process of message information, which is carried out in the information processing apparatus according to the present invention;

FIG. 9 (D, E and F) is a representation for explaining changes of the screen image displayed in the editing process of message information subsequent to FIG. 8;

FIG. 10 (G, H and I) is a representation for explaining changes of the screen image displayed in the editing process of message information subsequent to FIG. 9;

FIG. 11 is a flowchart for explaining the editing process of message information carried out in the information processing apparatus according to the present invention;

FIG. 12 is a flowchart for explaining display of an edit processing menu and a selected process, which are executed in the processing shown in FIG. 11;

FIG. 13 is a representation for explaining one example of scrolling of a screen image using a touch panel by a conventional method; and

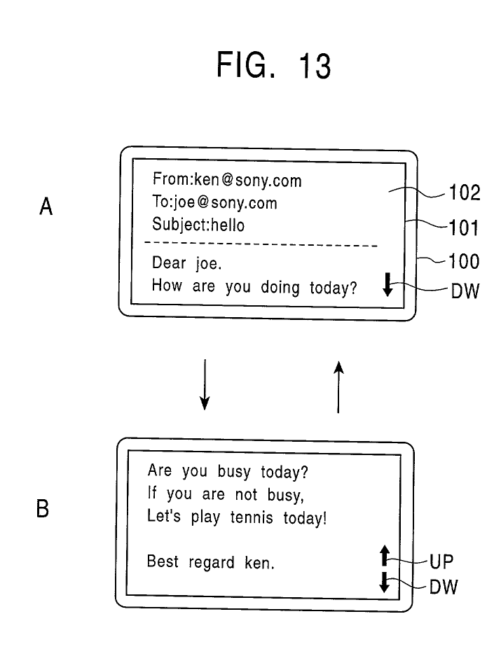

FIG. 14 is a representation for explaining a process of selecting one item from a menu using a touch panel by a conventional method.

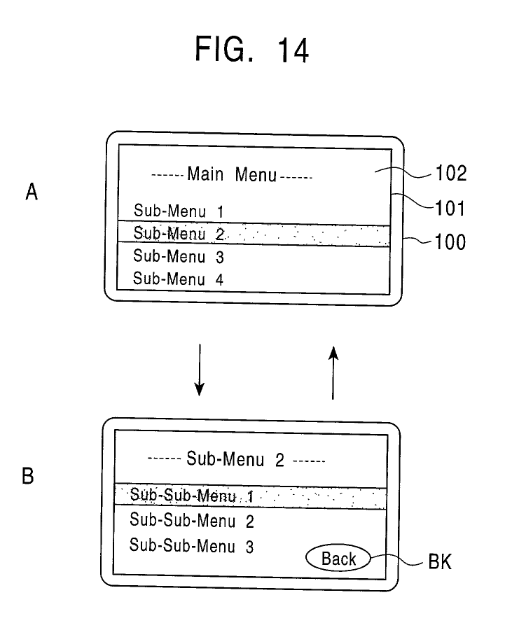

### DETAILED DESCRIPTION OF THE PREFERRED EMBODIMENTS

One embodiment of an information processing apparatus, an information inputting device and an information processing main unit according to the present invention will be described below with reference to the drawings. In the following embodiment, the information processing apparatus, the information inputting device and the information processing main unit are described, by way of example, in connection with the case where the present invention is applied to a pager which can perform two-way communicating and has the so-called E-mail function to receive message information (character information) and produce and transmit message information to a target destination.

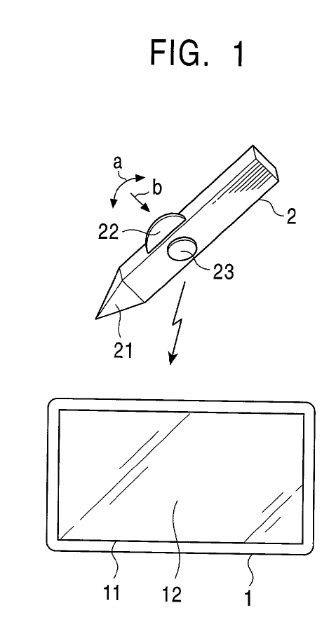

FIG. 1 is a schematic view for explaining a pager as one embodiment of the information processing apparatus. The pager of this embodiment comprises, as shown in FIG. 1, two sections; i.e., a main unit (section) 1 and an input device (section) 2. The main unit 1 is constituted by the processing main unit according to the present invention, and the input device 2 is constituted by the information inputting device according to the present invention.

As shown in FIG. 1, the main unit 1 of the pager according to this embodiment includes an LCD 11 that is constituted by a display device having a relatively large display screen. A touch panel 12 is attached to the overall surface of the display screen of the LCD 11, and serves as coordinate position detecting means for detecting coordinates of a position on the display screen (i.e., a pressed position) to which pressure is applied upon contact of a touch pen or the like.

The LCD 11 of the main unit 1 displays received E-mail (received message information), E-mail (transmitted message information) produced in and transmitted from the main unit 1, etc. Also, the transmitted message information is produced using the LCD 11 and the touch panel 12 attached to the display screen of the LCD 11. In this case, based on information displayed on the display screen of the LCD 11, a user can specifically recognize a predetermined pressed position or field against which the user should contact a pen or the like to input information.

Then, when the user contacts a pen or the like against a position on the touch panel 12 corresponding to the target information displayed on the display screen of the LCD 11, the coordinates of the contact position are detected in the main unit 1. In accordance with the detected coordinates, the main unit 1 can specify an input item and execute the processing corresponding to the specified input item.

More specifically, though also described later, a software keyboard made up of 26 alphabet letters, necessary symbols, necessary function keys, etc. are displayed on the display screen of the LCD 11. By contacting a pen or the like against a position on the touch panel 12 corresponding to the display area of a target letter or symbol, the user can input the letter or symbol and produce, e.g., the message information to be transmitted as E-mail.

On the other hand, the input device 2 is of the socalled pen type as shown in FIG. 1, and comprises a tip portion 21 brought into contact against the touch panel 102 for designating coordinates on the display screen, a rotating wheel (first operating means) 22 capable of being not only rotated as indicated by an arrow a in FIG. 1, but also depressed toward the interior of the input device 2 as indicated by an arrow b in FIG. 1, and an auxiliary button switch (second operating means) 23 capable of being depressed toward the interior of the input device 2.

When the rotating wheel 22 is rotated, the input device 2 transmits a signal, which represents the rotating operation applied to rotate the rotating wheel 22, to the main unit 1 through wireless communication. Likewise, when the rotating wheel 22 is depressed, the input device 2 transmits a signal, which represents the depressing operation applied to the rotating wheel 22, to the main unit 1 through wireless communication, and when the auxiliary button 23 is depressed, the input device 2 transmits a signal, which represents the depressing operation applied to the auxiliary button 23, to the main unit 1 through wireless communication.

The main unit 1 is constructed to be able to receive a signal transmitted from the input device 2 and to, in accordance with the received signal, execute such processing as to scroll displayed information, select and decide an optional item, or cancel an image displayed on the screen.

[Main Unit 1]

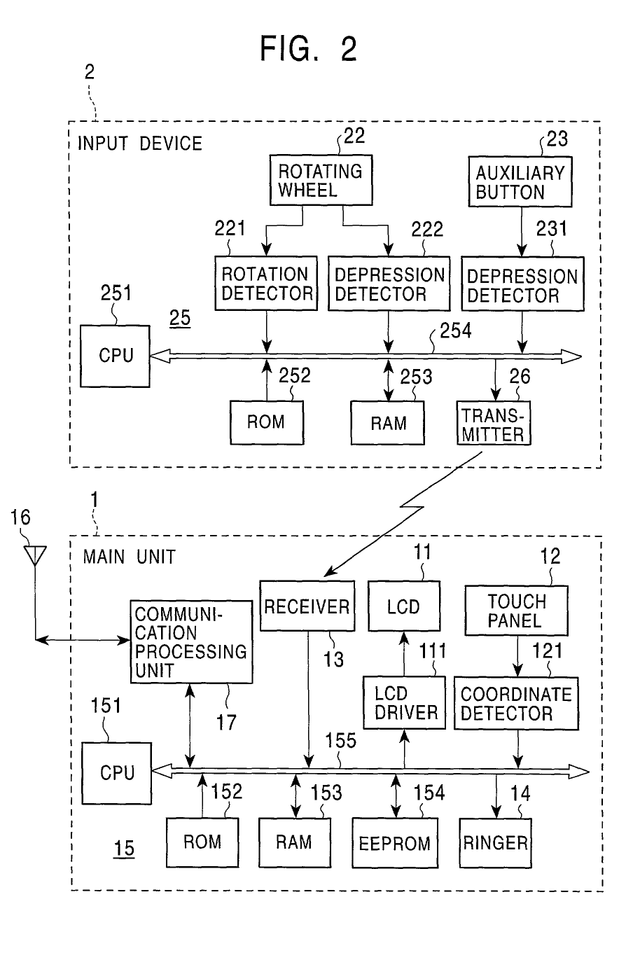

One example of detailed construction of the main unit 1 and the input device 2 will be described below. FIG. 2 is a block diagram for explaining the exemplified construction of the main unit 1 and the input device 2 of the pager according to this embodiment. A lower block of FIG. 2 represents the construction of the main unit 1, and an upper block of FIG. 2 represents the construction of the input device 2. A description is first made of the main unit 1.

As shown in FIG. 2, the main unit 1 comprises an LCD 11, an LCD driver 111, a touch panel 12, a coordinate detector 121, a receiver 13, a ringer 14, a control unit 15, a transmitting/receiving antenna 16, and a communication processing unit 17. The control unit 15 controls the other various components of the main unit 1.

In the main unit 1 of this embodiment, as shown in FIG. 2, the control unit 15 is constituted by a microcomputer comprising a CPU (Central Processing Unit) 151, a ROM (Read Only Memory) 152, a RAM (Random Access Memory) 153, and an EEPROM (Electrically Erasable and Programmable ROM) 154, which are interconnected via a CPU bus 155.

The ROM 152 stores programs, data, etc. necessary for executing various kinds of processes. The RAM 153 is mainly employed as a working area in the processing by, for example, temporarily storing data, etc. generated in intermediate steps of the various kinds of processes.

The EEPROM 154 stores setting parameters in the case of employing the apparatus in a mode where just preceding setting conditions, etc. are stored even upon power-off of the main unit 1 and the apparatus is set to the same conditions upon subsequent power-on, or stores received Email (received message information) addressed to the apparatus itself, E-mail (transmitted message information) transmitted from the apparatus, etc. Thus, the EEPROM 154 is a nonvolatile memory capable of holding data stored therein even after power-off of the main unit 1.

[Process of Receiving Information]

When main power is turned on, the main unit 1 of this embodiment is brought into a mode of waiting for mail (information) to be received, and detects arrival of the mail at the apparatus itself. More specifically, a signal received by the transmitting/receiving antenna 16 of the main unit 1 is supplied to the communication processing unit 17. The communication processing unit 17 executes the processing to demodulate and decode the received signal from the transmitting/receiving antenna 16 for conversion into a signal capable of being processed by the main unit 1, and then supplies the converted signal to the control unit 15.

When the signal from communication processing unit 17 indicates arrival of mail addressed to the apparatus itself, the control unit 15 controls the ringer 14 to generate ringer sounds, thereby informing the user of arrival of mail at his or her apparatus. Then, upon the user operating a predetermined button switch provided on the main unit 1, the ringer sounds are stopped and information, such as the phone number of the other party from which the mail has been received, is displayed on the display screen of the LCD 11 through the LCD driver 111 under control of the control unit 15.

Though not shown, the main unit 1 of this embodiment includes a vibrator as well. When mail arrives at the apparatus itself, the vibrator is vibrated to inform the user of arrival of the mail.

In this embodiment, E-mail may be directly transmitted to a pager of the other party (destination), or may be transmitted to a server managed by a telephone company, etc., for which a user of the pager of the other party subscribes, and then loaded in a target mail box (E-mail storage area) of the other party, which is provided in the server.

In the latter case, the user of the pager having received the E-mail can obtain the E-mail (received message information) addressed to his or her pager by accessing the relevant server. Then, in a similar way as described above, the E-mail (received message information) addressed to the apparatus itself of this embodiment is supplied to the control unit 15 through the transmitting/receiving antenna 16 and the communication processing unit 17. Thereafter, the control unit 15 loads the E-mail in a received message storage area of the EEPROM 154.

For example, when the user operates a predetermined button switch provided on the main unit 1 or provides an instruction through the touch panel 12 attached to the display screen of the LCD 11, the control unit 15 reads the target received message information out of the EEPROM 154 and displays the message information on the display screen of the LCD 11 through the LCD driver 111. Thus, display of information is executed as a sequence of operations for displaying the information on the display screen of the LCD 11 through the LCD driver 111 under control of the control unit 15.

Although the LCD 11 of the main unit 1 has a relatively large display screen, it cannot display the message information spreading over several tens lines at a time. The apparatus of this embodiment is therefore designed such that, for a long text of message information of E-mail, etc. displayed on the display screen of the LCD 11 of the main unit 1, the user can view the whole of message information by rotating the rotating wheel 22 of the input device 2 and smoothly scrolling the screen image as described later.

To execute such later-described processing in the main unit 1 in accordance with an instruction from the input device 2, the main unit 1 of this embodiment includes the receiver 13 for close range communication, which receives a signal representing rotation or depression of the rotating wheel 22 and a signal representing depression of the auxiliary button 23, these signals being transmitted from the input device 2 to the main unit 1 as described later.

[Process of Transmitting Information]

When producing E-mail (transmitted message information) to be transmitted to the other target party in the main unit 1 of this embodiment, the user performs a predetermined operation to display the software keyboard on the LCD 11 and then inputs character information by contacting the tip portion 21 of the input device 2 against predetermined positions on the touch panel 12 successively.

The coordinates of each position on the touch panel 12, against which the tip portion 21 of the input device 2 is contacted, are detected by the coordinate detector 121, and information indicating the detected coordinates is supplied to the control unit 15. In accordance with the information indicating the detected coordinates from the coordinate detector 121, the control unit 15 specifies the information instructed by the user.

Under control of the control unit 15, the specified information is displayed in a predetermined position of the display screen of the LCD 11 through the LCD driver 111, and is temporarily stored in the RAM 153 at the same time. Then, by repeating the operation of inputting information, the information instructed by the user is specified successively, and display and temporary storage of the specified information are also repeated. As a result, the message information of E-mail to be transmitted to the other target party is produced and stored in the RAM 153.

Also, when producing the message information of E-mail, the user can not only confirm the message information, which is now being produced, by rotating the rotating wheel 2 of the input device 2 and smoothly scrolling the screen image, but also perform editing of the message information, e.g. copying, pasting and cutting, as described later in detail.

In this embodiment, the transmitted message information thus produced and stored in the RAM 153 is loaded and held in a transmitted message storage area of the EEPROM 154 after completion of the information producing process so that the user may edit or transmit the loaded message information.

Subsequently, when the user performs a predetermined operation for instructing transmission of the message information, the control unit 15 places a telephone call to the instructed other party and connects a communication line. Thus, the control unit 15 in the main unit 1 of this embodiment also has the function of dialing a number. Then, the control unit 15 reads the target message information loaded in the transmitted message storage area of the EEPROM 154, and transmits the message information to the other target party via the connected transmission line.

Consequently, the main unit 1 of the pager of this embodiment is able to receive the message information addressed to the pager itself, and to transmit the message information addressed to the other target party for realizing two-way communication. Further, as described later, the main unit 1 has the function of close range communication for receiving a signal from the input device 2, and can execute the processing corresponding to the signal from the input device 2, e.g., the process of scrolling the information displayed on the display screen of the LCD 11.

[Input Device 2]

The input device 2 will be described below in more detail. As seen from an external appearance shown in FIG. 1, the input device 2 is of the pen type having the tip portion 21 that is brought into contact against the touch panel 102 provided in the main unit 1. In other words, the input device 2 has the function of so-called touch pen for making the input operation through the touch panel.

The input device 2 of this embodiment comprises, as shown in FIG. 2, a rotating wheel 22, a rotation detector 221, a depression detector 222, an auxiliary button 23, a depression detector 231, a control unit 25, and a transmitter 26. The control unit 25 is constituted by a microcomputer comprising a CPU 251, a ROM 252 and a RAM 253, which are interconnected via a CPU bus 254.

The ROM 252 of the control unit 25 stores programs, data, etc. necessary for executing various kinds of processes, etc. The RAM 253 is mainly employed as a working area in the processing by, for example, temporarily storing data, etc. generated in intermediate steps of the various kinds of processes.

As described before in connection with FIG. 1, the rotating wheel 22 is capable of being rotated and depressed. As shown in FIG. 2, the rotation detector 221 and the depression detector 222 are connected to the rotating wheel 22.

The rotation detector 221 detects change in rotational angle of the rotating wheel 22 and notifies the detected change to the control unit 25. More specifically, the rotation detector 221 detects the rotating direction of the rotating wheel 22 (i.e., the direction in which the rotating wheel 22 is rotated) and the amount of rotation of the rotating wheel 22, and then notifies the detected direction and amount to the control unit 25.

Upon receiving the notice of the direction and amount of rotation of the rotating wheel 22 from the rotation detector 221, the control unit 25 creates a signal containing the received information, i.e., a signal representing the rotating operation applied to the rotating wheel 22, and transmits the signal to the main unit 1 through the transmitter 26.

Also, when the rotating wheel 22 is depressed by the user, the depression detector 222 detects the depressing operation and notifies the depression of the rotating wheel 22 to the control unit 25. Upon receiving the notice of the depression of the rotating wheel 22 from the depression detector 222, the control unit 25 creates a signal representing the depressing operation applied to the rotating wheel 22, and transmits the signal to the main unit 1 through the transmitter 26.

In this embodiment, as described before in connection with FIG. 1, the auxiliary button 23 is capable of being depressed. Further, the depression detector 231 is connected to the auxiliary button 23. When the auxiliary button 23 is depressed by the user, the depression detector 231 detects the depressing operation and notifies the depression of the auxiliary button 23 to the control unit 25.

Upon receiving the notice of the depression of the auxiliary button 23 from the depression detector 231, the control unit 25 creates a signal representing the depressing operation applied to the auxiliary button 23, and transmits the signal to the main unit 1 through the transmitter 26.

The transmitter 26 transmits, as described before in connection with FIG. 1, the signal representing the rotating operation applied to the rotating wheel 22, the signal representing the depressing operation applied to the rotating wheel 22, and the signal representing the depressing operation applied to the auxiliary button 23, which are created in the control unit 25, to the main unit 1.

Thus, the input device 2 of this embodiment has the function of inputting information to the main unit 1 through the touch panel 12 attached to the display screen of the LCD 11 of the main unit 1. It also has the function of close range communication for transmitting, to the main unit 1, the signal representing the rotating operation applied to the rotating wheel 22, the signal representing the depressing operation applied to the rotating wheel 22, and the signal representing the depressing operation applied to the auxiliary button 23.

In addition, the information displayed on the display screen of the LCD 11 is scrolled with the rotation of the rotating wheel 22 of the input device 2. Also, a menu item is selected and decided with the rotation and depression of the rotating wheel 22, and a menu image on the screen is canceled with the depression of the auxiliary button 23.

[Process of Transmitting Signal from Input Unit 2]

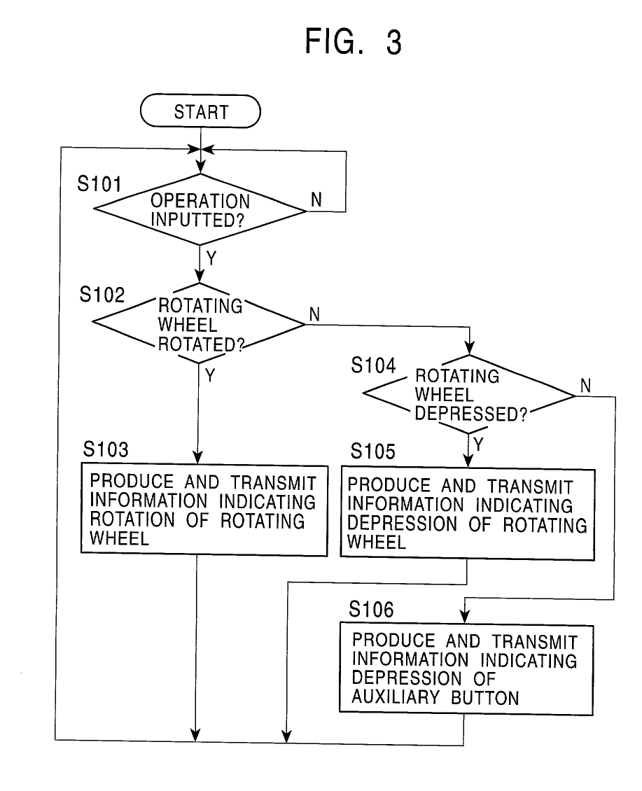

The signal transmitting process executed in the input unit 2 of this embodiment will be described below. FIG. 3 is a flowchart for explaining the signal transmitting process executed in the input device 2 of this embodiment. The processing shown in FIG. 3 is executed in the control unit 25 of the input device 2.

The control unit 25 of the input device 2 of this embodiment monitors detection outputs of the rotation detector 221, the depression detector 222 and the depression detector 231 at intervals of a predetermined time, for example, and determines whether the user has operated the rotating wheel 22 or the auxiliary button 23 (step S101).

If the determination process of step S101 determines that neither the rotating wheel 22 nor the auxiliary button 23 is operated, the processing of step S101 is repeated. If the determination process of step S101 determines that the rotating wheel 22 or the auxiliary button 23 has been operated, the control unit 25 determines whether the rotating wheel 22 has been operated by the user (step S102).

If the determination process of step S102 determines that a detection output is supplied from the rotation detector 221 and the rotating wheel 22 has been rotated, the control unit 25 creates a signal containing information that indicates the direction and amount of rotation of the rotating wheel 22, i.e., a signal representing the rotating operation applied to the rotating wheel 22, in accordance with the detection output from the rotation detector 221, and transmits the signal to the main unit 1 through the transmitter 26 (step S103). Thereafter, the control unit 25 repeats the processing from step S101.

If the determination process of step S102 determines that the rotating wheel 22 is not rotated, the control unit 25 determines whether the rotating wheel 22 has been depressed (step S104). If the determination process of step S104 determines that a detection output is supplied from the depression detector 222 and the rotating wheel 22 has been depressed, the control unit 25 creates a signal representing the depressing operation applied to the rotating wheel 22 in accordance with the detection output from the depression detector 222, and transmits the signal to the main unit 1 through the transmitter 26 (step S105). Thereafter, the control unit 25 repeats the processing from step S101.

Further, if the determination process of step S104 determines that the rotating wheel 22 is not depressed, the control unit 25 determines that the user has applied the operation to depress the auxiliary button 23. Then, the control unit 25 creates a signal representing the depressing operation applied to the auxiliary button 23 in accordance with the detection output from the depression detector 231, and transmits the signal to the main unit 1 through the transmitter 26 (step S106). Thereafter, the control unit 25 repeats the processing from step S101.

Thus, the input device 2 of this embodiment is constructed to be able to receive the operation applied to the rotating wheel 22 or the auxiliary button 23 at all times, to create a signal indicating the received operation, i.e., a signal representing how which one of the input operating components has been operated, and to transmit the signal to the main unit 1 through wireless communication.

[Processing executed in Main Unit 1]

Processing executed in the main unit 1 in response to the signal transmitted from the input device 2 through wireless communication will be described below. The following description is made of (1) scrolling process of displayed information, (2) process of selecting and deciding an item from a hierarchical menu, and (3) editing process of transmitted message information. [(1) Scrolling Process of Displayed Information]

The scrolling process of displayed information will be first described. In the pager of this embodiment, as described before in connection with FIG. 1, when displaying received message information of E-mail addressed to the pager itself or when producing or editing message information of E-mail to be transmitted to the other target party, the message information can be scrolled by rotating the rotating wheel 22 of the input device 2 if the message information is too long to be displayed on the display screen of the LCD 11 of the main unit 1 at a time.

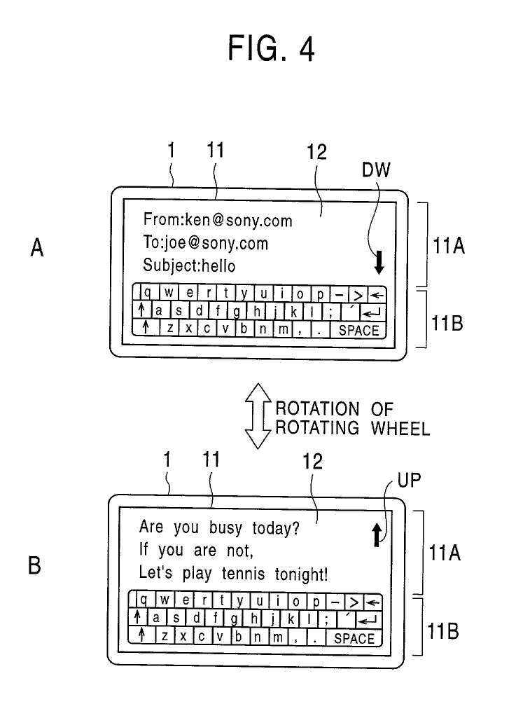

A description is made here of, for example, the case of producing transmitted message information to be transmitted as E-mail to the other target party. FIG. 4 (A and B) is a representation for explaining the case where the message information is scrolled in the screen image for producing the transmitted message information. When the user selects, for example, an option item for producing the transmitted message information from a main menu displayed on the display screen of the LCD 11 in the main unit 1 of this embodiment, the control unit 15 of the main unit 1 is brought into a mode of producing the transmitted message information.

In the mode of producing the transmitted message information, the control unit 15 reads the necessary information out of the ROM 102, forms a transmitted-messageinformation producing screen image, which includes a software keyboard for inputting character information, and displays the screen image on the LCD 11 as shown in FIG. 4.

In this embodiment, as shown in FIG. 4, the upper side of the display screen of the LCD 11 in the main unit 1 provides an information display/input area 11A, and the lower side of the display screen of the LCD 11 provides a software keyboard display area 11B. When producing the transmitted message information, the tip portion 21 of the input device 2 is contacted against a position on the touch panel 12 corresponding to the display position of a target character in the software keyboard displayed in the display area 11B.

As a result, the coordinates of the position on the touch panel 12 attached to the LCD 11, against which the tip portion 21 of the input device 2 is contacted, are detected by the main unit 1, and the character instructed to be inputted to the main unit 1 is specified in accordance with the detected coordinates. The specified character is then displayed successively in the information display/input area 11A as shown in FIG. 4.

Thus, message information of even a long text can be easily produced in the main device 1 by inputting the character information successively using the software keyboard. During the process of producing the transmitted message information or after finishing to produce the transmitted message information, the user pager often desires to display in the transmitted message information having been produced.

In such a case, the user rotates the rotating wheel 22 of the input device 2 in the mode of producing the transmitted message information. The signal representing the rotating operation applied to the rotating wheel 22 is thereby transmitted from the input device 2 to the main unit 1 as described above. Upon receiving the information indicating the rotation of the rotating wheel 22, the control unit 15 of the main unit 1 displays a next frame of image in accordance with the signal representing the rotation. In other words, the control unit 15 specifies the transmitted message information, which has been produced and is to be next displayed as one frame of image, and displays the specified message information as displayed information.

For example, when the downward arrow DW indicates, as shown in FIG. 4A, that there is information subsequent to the message information displayed in the information display/input area 11A, the rotating wheel 22 of the input device 2 is rotated so as to scroll the message information upward of the display screen of the LCD 11.

In accordance with the signal representing the rotating operation applied to the rotating wheel 22, which is transmitted from the input device 2, i.e., depending upon the direction and amount of rotation of the rotating wheel 22, the main unit 1 scrolls the message information (displayed information) upward of the display screen in a predetermined unit, e.g., in units of line or page, and specifies the transmitted message information for one frame of image to be next displayed, thereby displaying the specified information as shown in FIG. 4B.

Also, when the upward arrow UP indicates, as shown in FIG. 4B, that there is information prior to the message information displayed in the information display/input area 11A, the rotating wheel 22 of the input device 2 is rotated so as to scroll the displayed information downward of the display screen of the LCD 11.

In accordance with the signal representing the rotating operation applied to the rotating wheel 22, which is transmitted from the input device 2, the main unit 1 scrolls the displayed information downward of the display screen in a predetermined unit, e.g., in units of line or page, and specifies the message information for one frame of image to be next displayed, thereby displaying the specified information as shown in FIG. 4A.

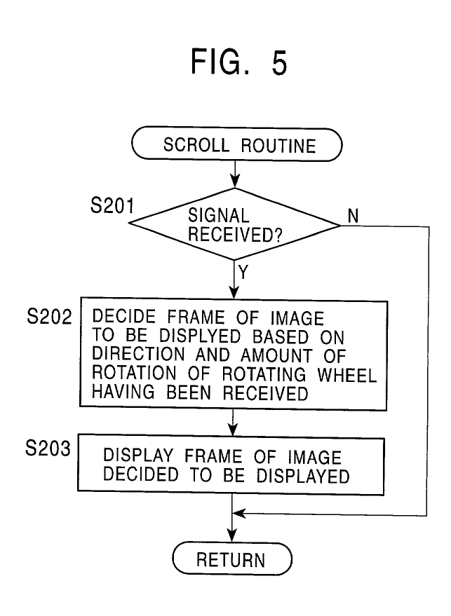

FIG. 5 is a flowchart for explaining the screen image scrolling process carried out in the main unit 1 in the mode of producing the transmitted message information. The scrolling process of FIG. 5 is executed at predetermined time intervals in the main routine executed in the mode of producing the transmitted message information.

More specifically, the control unit 15 of the main unit 1 executes the scrolling process of FIG. 5 at the predetermined time intervals in the mode of producing the transmitted message information. First, the control unit 15 of the main unit 1 determines whether the signal representing the rotating operation applied to the rotating wheel 22 of the input device 2 has been received from the input device 2 (step S201). If the determination process of step S201 determines that the signal representing the rotating operation applied to the rotating wheel 22 is not received, the control unit 15 brings the processing of FIG. 5 into an end and returns to the main routine in the mode of producing the transmitted message information.

If the determination process of step S201 determines that the signal representing the rotating operation applied to the rotating wheel 22 has been received, the control unit 15 of the main unit 1 decides (specifies) the message information (displayed information), which is to be next displayed, in accordance with the direction and amount of rotation of the rotating wheel 22 that are contained in the received signal representing the rotating operation (step S202).

Then, the control unit 15 displays the message information, decided in step S202, on the display screen of the LCD 11 through the LCD driver 111 (step S203). Then, the control unit 15 brings the processing of FIG. 5 into an end and returns to the main routine in the mode of producing the transmitted message information.

As described above, the user of the pager of this embodiment can scroll the screen image depending upon the direction and amount of rotation of the rotating wheel 22 by rotating the rotating wheel 22 of the input device 2. Accordingly, the user can more easily realize the scrolling than a conventional method of, e.g., requiring the user to apply pressure to a pressed field for scrolling provided on the touch panel each time when the screen image is to be scrolled.

Stated otherwise, in this embodiment, since the user can perform the scrolling operation continuously by rotating the rotating wheel 22, the smooth scrolling operation can be simply and surely achieved. Correspondingly, the displayed information on the display screen of the LCD 11 of the main unit 1 can be smoothly scrolled in a continuous manner.

Further, since there is no need of setting the pressed field for scrolling on the touch panel attached to the display screen of the LCD 11 of the main unit 1, the display screen of the LCD 11 can be effectively employed. In other words, another information not related to the scrolling may be displayed in a predetermined area on the display screen of the LCD 11, which has been conventionally employed as the pressed field for scrolling.

While, in the example of FIG. 4, the information display/input area 11A is set as one frame of image to be scrolled at a time and information in one frame of image is all changed in the scrolling process, the screen image may be scrolled in units of line. Thus, the displayed information can be smoothly scrolled depending upon the direction and amount of rotation of the rotating wheel 22 in the input device 2.

The amount by which the displayed information is scrolled depending upon the amount of rotation of the rotating wheel 22 may be optionally set or changed in the main unit 1 so that the scroll amount can be set in accordance with the user's preference. The scrolling in units of page (one full frame of image) is convenient to scroll the screen image over a large span with a relatively small amount of rotating operation, whereas the scrolling in units of line provides a relatively smooth feel in the operation. The scrolling in units of half page (1/2frame of image), for example, is intermediate between those two scrolling modes, and is advantageous in that text sentences, etc. are displayed without interruption and the displayed information is easy to read even when the displayed information spreading over two frames of image is scrolled.

The above description has been made of, by way of example, the scrolling process executed in the mode of producing the transmitted message information of E-mail. However, when displaying and reading the received message information of E-mail, or when editing the produced message information of E-mail, the main unit 1 can also similarly scroll information displayed on the LCD 11 by rotating the rotating wheel 22 of the input device 2.

[(2) Process of Selecting and Deciding Item from Hierarchical Menu]

The process of selecting and deciding an item from a hierarchical menu will be described below. The pager of this embodiment is constructed to be able to execute various kinds of processes to, e.g., receive and transmit E-mail, produce and edit message information to be transmitted as Email, register, update and delete the so-called phone book information such as the name, phone number and E-mail address of each of necessary other parties, and search the phone book information. Those various kinds of processes can be executed by selecting corresponding items from a menu displayed on the LCD 11 of the main unit 1.

Since the pager of this embodiment contains many processes to be executed, the menu is prepared in a hierarchical structure so that the target process can be promptly selected and decided. Looking at the processing just related to E-mail, for example, there are a process of displaying received E-mail (received message information), a process of producing transmitted E-mail (transmitted message information), a process of editing the transmitted message information, and a process of transmitting the transmitted message information.

In this embodiment, the main menu includes an optional item indicating the processing related to, e.g., E-mail. Selecting this optional item displays a lower-level sub-menu including such optional items as indicating the process of displaying the received message information, the process of producing the transmitted message information, the process of editing the transmitted message information, and the process of transmitting the transmitted message information.

Those ones of the optional items in the sub-menu, which can be further divided, are each prepared as having a sub-sub-menu, thereby providing a hierarchical menu as a whole. In the pager of this embodiment, the user can easily and promptly find and select the target optional item from the hierarchical menu by using the rotating wheel 22 and the auxiliary button 23 of the input device 2.

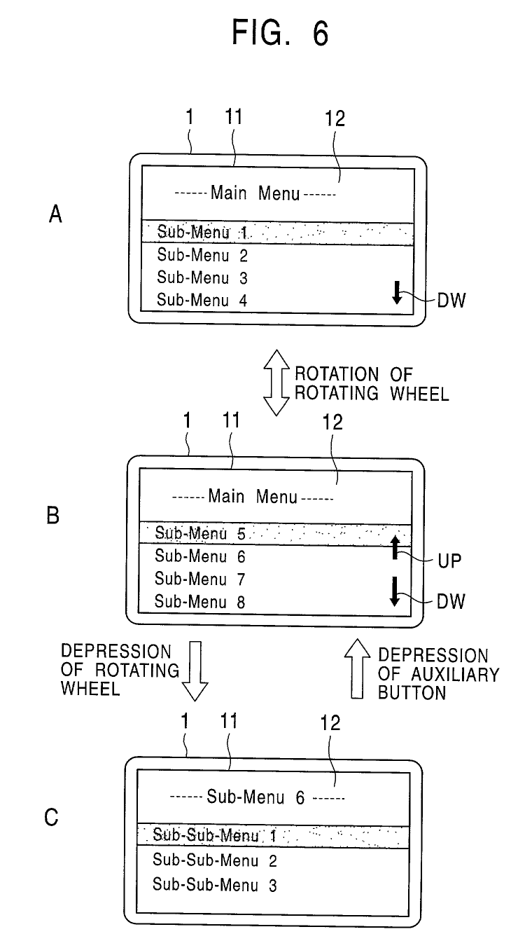

FIG. 6 (A, B and C) is a representation for explaining the process of selecting and deciding one of option items from a hierarchical menu. In the pager of this embodiment, by performing such a predetermined operation as depressing a menu display key provided on the main unit 1, a main menu is displayed on the display screen of the LCD 11 of the main unit 1 as shown in FIG. 6A.

When the rotating wheel 22 of the input device 2 is rotated, the signal representing the rotating operation applied to the rotating wheel 22 is transmitted from the input device 2 to the main unit 1, whereby one of the option items displayed in the main menu can be selected. In an example of FIG. 6A, a display line of “Sub-Menu 1 ” as one option item is highlighted (reversed in video), thus indicating that the cursor is positioned on “Sub-Menu 1” and this “Sub-Menu 1” is selected at the present. Also, in FIG. 6A, a downward arrow DW is displayed at a lower right corner of the display screen of the LCD 11 and indicates the presence of other menu items than displayed at the present.

Then, by rotating the rotating wheel 22 of the input device 2 so as to move the cursor position in the main menu downward of the display screen, the line on which the cursor is positioned, i.e., the highlighted line, is also moved successively downward of the display screen. Upon the highlighted line reaching the lowermost end of the display screen, the option items are scrolled up as shown in FIG. 6B so that the other option items subsequent to “Sub-Menu 5” than not displayed in FIG. 6A are displayed.

The user further rotates the rotating wheel 22 of the input device 2 so as to move and position the cursor on the target item in the main menu. In an example of FIG. 6B, the cursor is positioned on “Sub-Menu 6” and this “Sub-Menu 6” is selected. Also, in FIG. 6B, an upward arrow UP and a downward arrow DW are displayed at a lower right corner of the display screen of the LCD 11 and indicate the presence of other option items before and after the current screen image than displayed at the present.

When the user depresses the rotating wheel 22 of the input device 2 in the condition of FIG. 6B, the signal representing the depressing operation applied to the rotating wheel 22 is transmitted from the input device 2 to the main unit 1. Upon receiving the signal representing the depressing operation applied to the rotating wheel 22, the main unit 1 displays “Sub-Menu 6” selected in the main menu, as shown in FIG. 6C, based on judgment that the option item selected at the present has been decided as the target item.

Then, the user can now select one of option items in “Sub-Menu 6” shown in FIG. 6C by rotating the rotating wheel 22 of the input device 2. If “Sub-Menu 6” selected to be displayed is false and the target optional item is not contained in “Sub-Menu 6”, the user depresses the auxiliary button 23 of the input device 2.

In such a case, the signal representing the depressing operation applied to the auxiliary button 23 is transmitted from the input device 2 to the main unit 1. Upon receiving the signal representing the depressing operation applied to the auxiliary button 23, the main unit 1 returns the menu image to the higher-level main menu shown in FIG. 6B or 6A based on judgment that the menu image displayed at the present has been instructed to be canceled.

Accordingly, even when an option item is erroneously selected, the screen image displayed at the present can be canceled for return to the just preceding screen image. In the example of FIG. 6, it is possible to return to the higher-level main menu and select one of the sub-menus.

Thus, one of optional items can be selected by rotating the rotating wheel 22 of the input device 2, and the selection of the optional item is decided by depressing the rotating wheel 22. Further, the screen image displayed at the present can be canceled by depressing the auxiliary button 23.

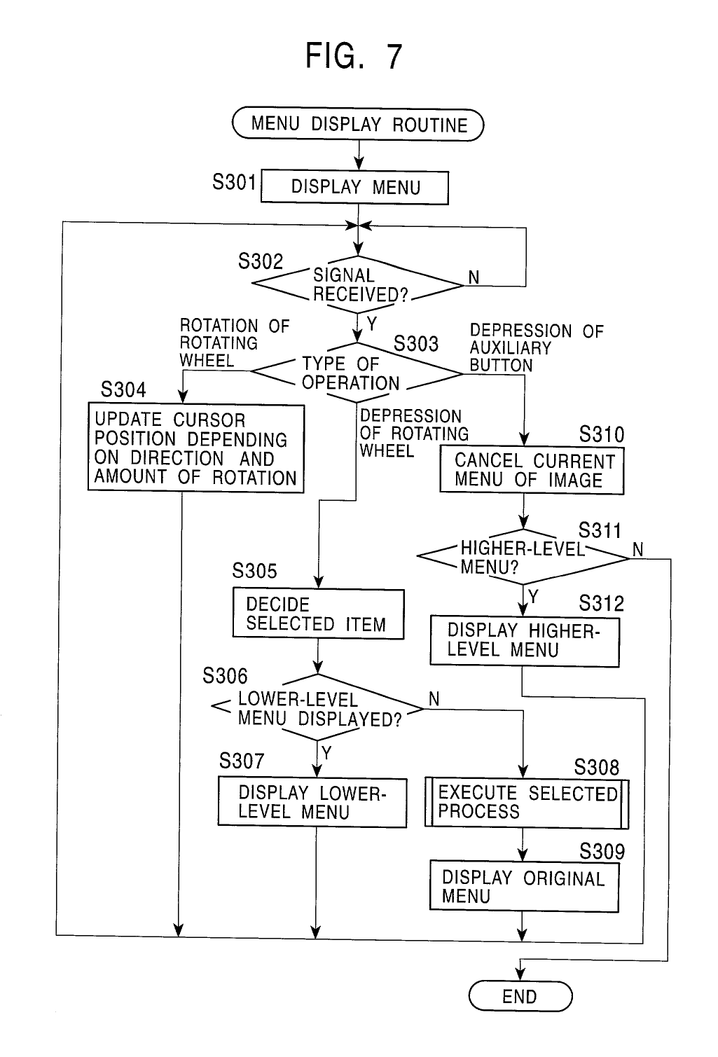

FIG. 7 is a flowchart for explaining the process of selecting and deciding one of option items from a hierarchical menu, which is carried out in the main unit 1 in accordance with the signal from the input device 2. The processing shown in FIG. 7 is executed in the control unit 15 of the main unit 1 when the predetermined operation for instructing display of the main menu is performed as described above.

When the control unit 15 of the main unit 1 detects that the predetermined operation for instructing display of the main menu has been performed by the user, it executes the processing shown in FIG. 7 and first displays the main menu instructed to be displayed (step S301). Then, the control unit 15 of the main unit 1 determines whether a signal has been received from the input device 2 through the receiver 13 (step S302).

If the determination process of step S302 determines that any signal from the input device 2 is not received, the control unit 15 repeats the processing of step S302. If the determination process of step S302 determines that a signal from the input device 2 has been received, the control unit 15 determines what operation is represented by the received signal, i.e., whether the received signal represents the rotation of the rotating wheel 22, the depression of the rotating wheel 22, or the depression of the auxiliary button 23 (step S303).

If the determination process of step S303 determines that the signal from the input device 2 represents the rotation of the rotating wheel 22, the control unit 15 changes the cursor position in accordance with the direction and amount of rotation of the rotating wheel 22, which are contained in the received signal, thereby selecting one of the optional items (step S304). Thereafter, the control unit 15 repeats the processing from step S302 and processes the signal from the input device 2.

Also, if the determination process of step S303 determines that the signal from the input device 2 represents the depression of the rotating wheel 22, the control unit 15 decides the option item in the menu, at which the cursor is positioned at that time, as the selected item (step S305).

Then, the control unit 15 determines whether the item decided in step S305 belongs to the display of the lowerlevel menu (step S306). If it is determined that the decided item belongs to the display of the lower-level menu, the control unit 15 displays the lower-level menu corresponding to the item decided in step S305 (step S307), and then repeats the processing from step S302.

If the determination process of step S306 determines that the item decided in step S305 does not belong to the display of the lower-level menu, the control unit 15 executes a concrete process corresponding to the selected item, e.g., the process of displaying the received message information and the process of producing the transmitted message information in the above-described example (step S308).

Subsequently, when the process executed in step S308 is completed, the control unit 15 displays the original menu image in this embodiment (step S309), which has been displayed at the time when the item has been selected and decided in step S305, and then repeats the processing from step S302.

If the determination process of step S303 determines that the signal from the input device 2 represents the depression of the auxiliary button 23, the control unit 15 cancels the currently displayed menu image (step S310) based on judgment that the menu image displayed at that time has been instructed to be canceled.

Then, the control unit 15 determines whether there is a menu at a higher level than the canceled menu image (step S311). If it is determined that there is an upper-level menu image, the upper-level menu image is displayed (step S312). In other words, the control unit 15 returns the screen image to the higher-level menu image, and then repeats the processing from step S302.

If the determination process of step S311 determines that there is no menu image at a higher level than the canceled menu image, i.e., if it is determined that the canceled menu image is the main menu image, the control unit completes the processing shown in FIG. 7 and transits to, e.g., the reception mode of waiting for an input signal.

As a result, selection of one of optional items in the menu image, decision of the selected item, and cancellation of the current menu image can be performed respectively with the rotation and depression of the rotating wheel 22 of the input device 2 and the depression of the auxiliary button 23 thereof. On this occasion, the user can easily and precisely find and select the target optional item to execute the target process just by operating the input device 2 with no need of the operation of moving the input device 2 itself, such as contacting the input device 2 against a predetermined pressed field on the touch panel.

[(3) Editing Process of Transmitted Message Information]

The editing process of message information of E-mail produced for transmission will be described below. The input device 2 of the pager of this embodiment includes, as shown in FIG. 1, the tip portion 21 (used for pressing the touch panel 12) that is contacted against the touch panel 12 to instruct a coordinate position on the touch panel 12.

Then, the editing process, such as copying, pasting and cutting, can be easily performed with the operation of contacting the top portion 21 of the input device 2 against the touch panel 12 and the operation of rotating or depressing the rotating wheel 22.

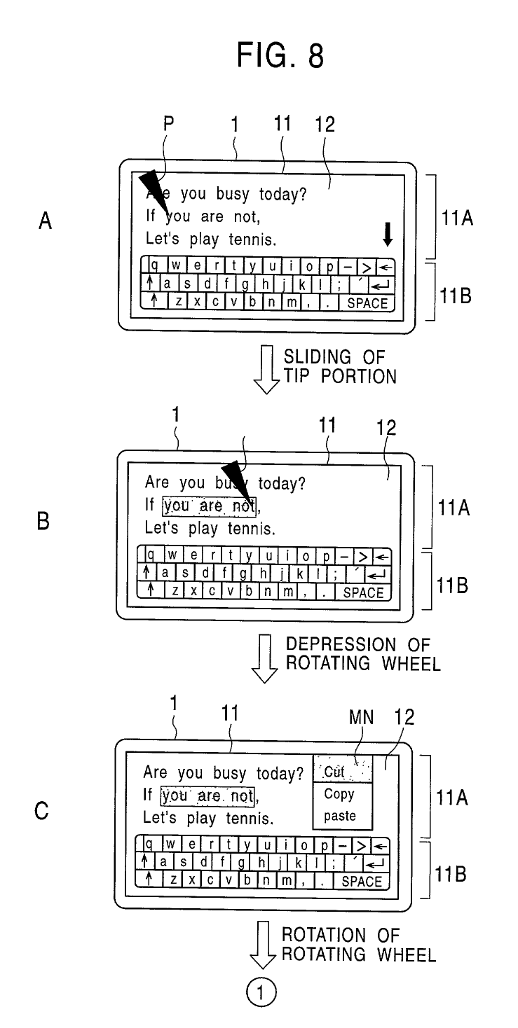

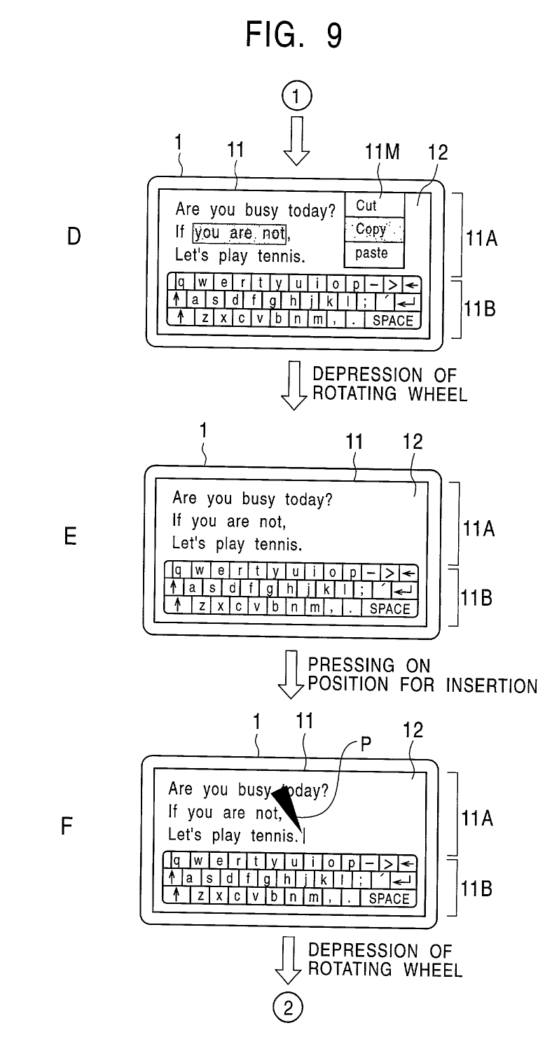

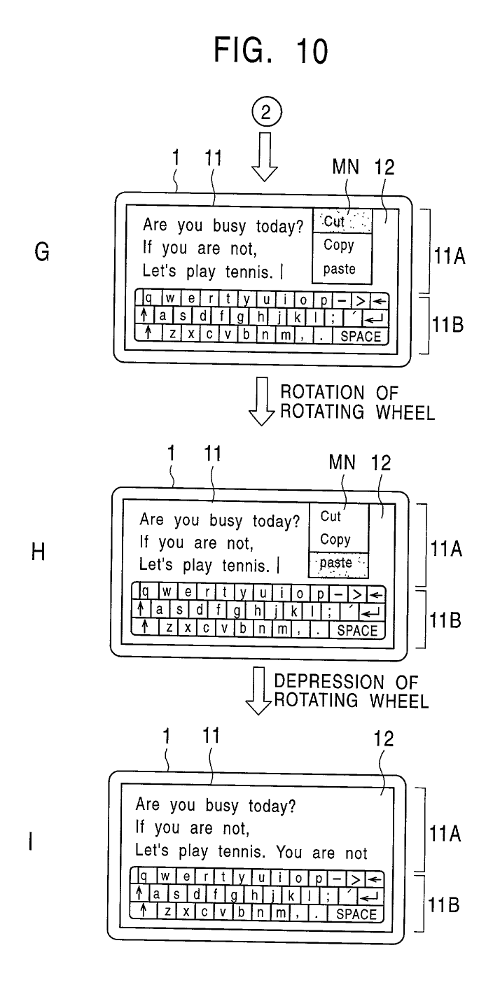

FIGS. 8 to 10 (A to I) are representations for explaining the process of editing message information of Email to be transmitted, and show changes of the screen image on the LCD 11 during the editing process. As described later in detail, FIG. 9 (D to F) show changes of the screen image subsequent to FIG. 8 (A to C), and FIG. 10 (G to I) show changes of the screen image subsequent to FIG. 9.

In the pager of this embodiment, as described above, when, for example, editing of the transmitted message information is selected from the menu and a text of the transmitted message information is selected which has been produced and stored in the EEPROM 154 and is to be now edited, the selected message information is displayed on the upper area 11A of the display screen of the LCD 11 and the software keyboard is displayed on the lower area 11B of the display screen of the LCD 11, as shown in FIG. 8A.

Herein, the editing process of the transmitted message information is described in connection with the case of pasting a sentence “you are not” at the second line in the transmitted message information displayed in the upper area 11A, shown in FIG. 8A, to a position after “tennis.” at the third line, i.e., the case of copying the sentence “you are not” at the second line and then pasting it to a position after “tennis.” at the third line.

As indicated by an pointing mark P in FIG. 8A, after the target message information has been displayed, the user presses the touch panel 12 by contacting the tip portion 21 of the input device 2 against a position on the touch panel 12 corresponding to the head of a character, word or sentence to be copied. Then, as indicated by the pointing mark P in FIG. 8B, the user slides the input device 2 from the head to the tail of the character, word or sentence to be copied, while continuing to press the touch panel 12.

With the sliding of the input device 2, the designated range is highlighted (inversed in video), by way of example, as shown in FIG. 8B, allowing the user to recognize at a glance what range from which point to which point has been designated. If the designated range is not false, the user depresses the rotating wheel 22 of the input device 2. Upon the depression of the rotating wheel 22, an editing menu MN for prompting the user to instruct how the designated range of the transmitted message information is to be edited is displayed as shown in FIG. 8C.

Then, by rotating the rotating wheel 22 of the input device 2 in the condition where the editing menu MN is displayed on the LCD 11 of the main unit 1 as shown in FIG. 8C, the user can select one of optional items, such as cutting (“Cut”), copying (“Copy”) and pasting (“Paste”), in the editing menu MN as shown in FIG. 9D.

Subsequently, when the user puts the cursor at a position of “Copy” in the editing menu MN as shown in FIG. 9D and depresses the rotating wheel 22 of the input device 2, the sentence in the designated range is temporarily stored in a buffer memory of the main unit 1, i.e., in the RAM 153 in this embodiment, and the designated range is released from the highlighted state as shown in FIG. 9E.

Thereafter, when the user contacts the tip portion 21 of the input device 2 against a position, to which the copied sentence is to be pasted, as indicated by the pointing mark P in FIG. 9F, the cursor is displayed at the contact position so that characters can be entered or pasted to the same position. By depressing the rotating wheel 22 of the input device 2 in such a condition, the editing menu MN is displayed again as shown in Fig. 10G.

Then, by rotating the rotating wheel 22 of the input device 2 in the condition where the editing menu MN is displayed, the target optional item is selected. In the illustrated example, “Paste” is now selected as shown in FIG. 10H. When the user depresses the rotating wheel 22 after “Paste”has been selected as shown in FIG. 10H, the sentence “you are not” is pasted to the position subsequent to “tennis.” at the third line as shown in FIG. 10I.

As a result, the user can easily and precisely edit the produced message information by contacting the tip portion 21 of the input device 2 against the touch panel 12 and rotating or depressing the rotating wheel 22 in a combined way.

The above description has been made of the example of copying and pasting the selected range of the message information. However, it is similarly possible to cut any unnecessary characters, words, sentences, etc. from the produced message information.

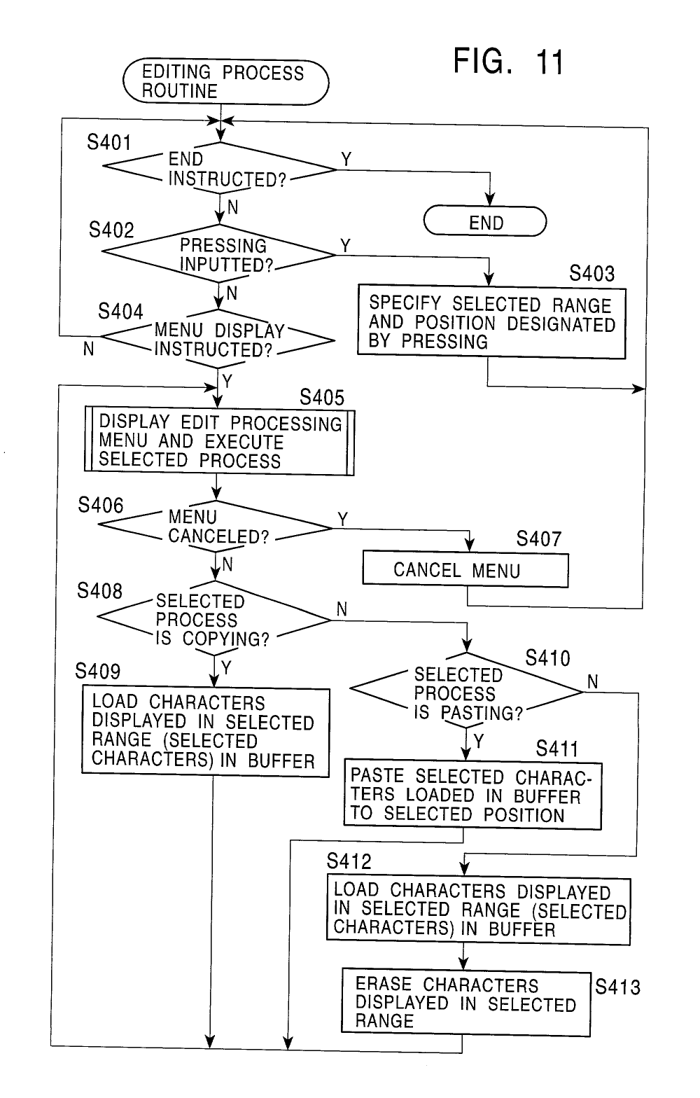

FIG. 11 is a flowchart for explaining the editing process of message information carried out in the main unit 1 in the mode of editing the transmitted message information. The processing shown in FIG. 11 is executed in the control unit 15 of the main unit 1 when the editing of the transmitted message information is selected from the menu as described above.

When the editing of the transmitted message information is selected, the control unit 15 of the main unit 1 determines whether the process of editing the transmitted message information has been instructed to come into an end (step S401). If it is determined that the end of the editing process has been instructed, the control unit 15 completes the processing of FIG. 11 for return to, e.g., the original menu image.

If the determination process of step S401 determines that the end of the editing process is not instructed, the control unit 15 of the main unit 1 determines whether the touch panel 12 has been pressed upon contact of the tip portion 21 of the input device 2 against the touch panel 12 (step S402). If the determination process of step S402 determines that the pressing has been inputted, the control unit 15 detects a coordinate position (coordinate position) of the tip portion 21 of the input device 2 on the touch panel 12, and specifies a selected range and position designated on the display screen (step S403). Thereafter, the control unit 15 repeats the processing from step S401.

The processing of step S403 is to receive designation of the range of character, word or sentence to be edited, thereby specifying the designated range as shown in FIGS. 8A and 8B, or is to receive designation of the position at which the character, word or sentence is to be pasted, thereby specifying the pasted position as shown in FIG. 9F.

If the determination process of step S402 determines that the pressing is not inputted, the control unit 15 of the main unit 1 determines whether display of an edit processing menu is instructed (step S404). In this embodiment, when the signal transmitted from the input device 2 represents the depression of the rotating wheel 22, the determination process of step S404 determines that the display of the edit processing menu is instructed.

If the determination process of step S404 determines that the display of the edit processing menu is not instructed, the control unit 15 repeats the processing from step S401. On the other hand, if the determination process of step S404 determines that the display of the edit processing menu is instructed, the control unit 15 executes the display of the edit processing menu and a selected process (step S405).

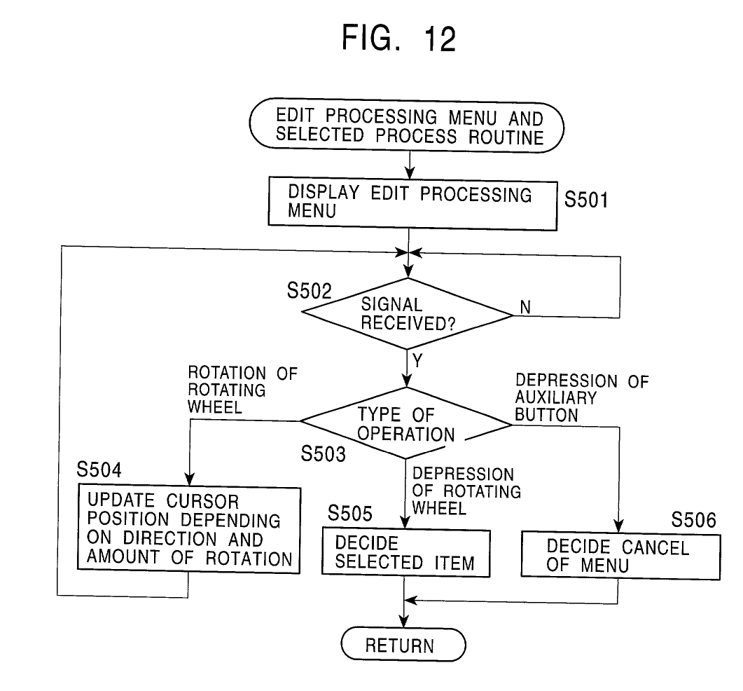

FIG. 12 is a flowchart for explaining the display of the edit processing menu and the selected process, which are executed in step S405. As shown in FIG. 12, if the display of the edit processing menu is instructed, the control unit 15 executes the processing of FIG. 12. More specifically, the control unit 15 first displays the edit processing menu lIC in the predetermined display area of the LCD 11 of the main unit 1 (step S501), and then determines whether a signal transmitted from the input device 2 has been received (step S502).

If the determination process of step S502 determines that any signal transmitted from the input device 2 is not received, the control unit 15 is brought into a state of waiting for a signal transmitted from the input device 2. If the determination process of step S502 determines that a signal transmitted from the input device 2 has been received, the control unit 15 determines what type of operation is represented by the received signal, i.e., determines whether the received signal represents the rotation of the rotating wheel 22, the depression of the rotating wheel 22, or the depression of the auxiliary button 23 (step S503).

If the determination process of step S503 determines that the signal from the input device 2 represents the rotation of the rotating wheel 22, the control unit 15 changes the cursor position in accordance with the direction and amount of rotation of the rotating wheel 22, which are contained in the received signal, thereby selecting an optional item (step S504). Thereafter, the control unit 15 repeats the processing from step S502 and executes the processing corresponding to the signal from the input device 2.

Also, if the determination process of step S503 determines that the signal from the input device 2 represents the depression of the rotating wheel 22, the control unit 15 decides, as a selected item, the optional item in the menu at which the cursor is positioned at that time (step S505). Thereafter, the control unit 15 brings the processing of FIG. 12 into an end for return to the processing shown in FIG. 11.

If the determination process of step S503 determines that the signal from the input device 2 represents the depression of the auxiliary button 23, the control unit 15 decides cancel of the currently displayed menu image (step S506) based on judgment that the menu image displayed at that time has been instructed to be canceled. Thereafter, the control unit 15 brings the processing of FIG. 12 into an end for return to the processing shown in FIG. 11.

Subsequently, in the determination process of step S406 shown in FIG. 11, the control unit 15 of the main unit 1 determines (in step S406) whether the cancel of the edit processing menu has been decided in the routine for the display of the edit processing menu and the selected process, which have been executed in step S405.

If the determination process of step S406 determines that the cancel of the edit processing menu has been decided, the control unit 15 of the main unit 1 cancels the edit processing menu MN and then repeats the processing from step S401. If the determination process of step S406 determines that the cancel of the edit processing menu is not decided, the control unit 15 determines (in step S408) whether the editing process decided in the processing of step S405 is copying.

Further, if the determination process of step S408 determines that the decided editing process is copying, the control unit 15 loads data of the character, word or sentence in the range, which has been specified in step S403, in the buffer memory (step S409) and then repeats the processing from step S405.

If the determination process of step S408 determines that the decided editing process is not copying, the control unit 15 determines whether the decided editing process is pasting (step S410). If the determination process of step S410 determines that the decided editing process is pasting, the control unit 15 executes the process of pasting the character information, which is loaded in the buffer memory, to the selected position specified in step S403 (step S411). Thereafter, the control unit 15 repeats the processing from step S405.

If the determination process of step S410 determines that the decided editing process is not pasting, the control unit 15 determines that the decided editing process is cutting. Then, the control unit 15 loads the character information in the selected range, which has been decided in step S402, in the buffer memory (step S412) and erases the characters displayed in the selected range (step S413). Thereafter, the control unit 15 repeats the processing from step S405.

Thus, with the pager of this embodiment, the user can easily and precisely input a selected range and position by contacting the tip portion 21 of the input device 2 against the touch panel 12 of the main unit 1, and can specify the editing process by rotating and depressing the rotating wheel 22 to copy, paste or cut character information in the selected range. The user can also cancel the edit processing menu by depressing the auxiliary button 23.

Stated otherwise, the user can input information to the main unit 1 through four input routes, i.e., operations of rotating the rotating wheel 22, depressing the rotating wheel 22, depressing the auxiliary button 23, and contacting the tip portion 21 of the input device 2 against the touch panel 12, for executing various kinds of processes in the main unit 1.

Additionally, in this embodiment, a due consideration is paid so as to keep the user from stepping into a false process. For example, unless the selected range or position is specified in step S403 shown in FIG. 11, the edit processing menu is not displayed. Further, unless the character information for pasting is loaded in the buffer memory, the pasting is prohibited.

Also, in this embodiment, the copying is a process of loading character information in the selected range in the buffer memory, and the character information in the selected range is left, as it is, in the screen image. The pasting is a process of displaying, at a selected position, the character information loaded in the buffer memory.

Further, the cutting is a process of loading character information in the selected range in the buffer memory, and then erasing the character information displayed in the selected range. The reason why the erased character information is loaded in the buffer memory is make it possible to promptly restore the character information even in the case, for example, where the user erases necessary information by a mistake. Accordingly, though not described above, a deleted character restoring process of displaying the cut character information at a designated position can also be performed in the foregoing embodiment.

In the above-described embodiment, one information processing apparatus comprises two sections, i.e., the main unit 1 and the input device 2. However, information can be inputted to the main unit 1 through the touch panel 12 as conventionally practiced, and hence the input device 2 may be purchased later as required. Stated otherwise, since the main unit 1 and the input device 2 are constructed as devices independently of each other, the main unit 1 and the input device 2 may be separately sold as independent pieces of equipment.

Also, while the main unit 1 and the input device 2 are described as being connected to each other through wireless communication in the above-described embodiment, the present invention is not limited to such a communication system. As a matter of course, the main unit 1 and the input device 2 may be connected to each other through wire. Communication through wire has an additional merit that the input device 2 can be supplied with power from the main unit 1 using the wire. When interconnecting the main unit 1 and the input device 2 through wireless or wire communication, any suitable one of various communication protocols can be used.

When interconnecting the main unit 1 and the input device 2 through wireless communication, it is a matter of course that signals can be transmitted and received using not only electric waves but also light such as an infrared ray.

Further, a signal may be transmitted from the main unit 1 and received by the input device 2. In this case, a transmitter for close range communication is provided in the main unit 1 and a receiver for close range communication is provided in the input device 2.

The above arrangement is advantageous, for example, in the case where the main unit 1 is present, but the input device 2, which should be located nearby, cannot be found when the user is going to use the information processing apparatus. More specifically, for example, a signal for instruction to generate alarm sounds is transmitted from the main unit 1 to the input device 2, and the input device 2 generates the alarm sounds upon receiving the transmitted signal. Thus, the user can easily find out the input device 2. As a matter of course, a caution may be given to the user with blinking of light or mechanical vibration other than generating an acoustic output such as alarm sounds.

The foregoing embodiment has been described in connection with the case of applying the present invention to a pager. However, applications of the present invention are not limited to a pager. The present invention is also applicable to various types of information processing apparatuses, including miniature personal information processing apparatuses called PDAs and electronic pads, small-sized information processing apparatuses such as pocket computers and notebook personal computers, etc.

More specifically, an information processing apparatus to which the present invention can be applied is not always required to have the two-way communicating function. The present invention is therefore applicable to an information processing apparatus that just receives and stores information and displays the received and stored information as required so that the user may view the information, or to another one that has, contrary to the above apparatus, only the function of receiving an input of information to be transmitted, storing the inputted information, and then transmitting it to the other target party as required.

Further, the present invention is applicable to an information processing apparatus that has not the communicating function at all, but just receives input of information, stores the inputted information, and displays it as required.

According to the present invention, as described above, since the input device includes rotatable operating means (first operating means), the user can smoothly scroll a screen image with a simple operation.

Since the rotatable operating means is capable of being also depressed, the user can promptly and precisely select and decide, for example, an optional item from a menu.

Since the input device includes another operating means (second operating means) in addition to the first operating means capable of being rotated and depressed, the user can further easily instruct cancel of a screen image.

It is hence possible to smoothly scroll a screen image, select and decide an optional item from a menu image, and cancel a menu image just by applying a simple operation to the input device with no need of moving the input device so as to contact against the main unit.

Additionally, since the user can also input an instruction to the main unit by contacting the tip portion of the input device against contact position detecting means provided in the main unit, a user's instruction to the main unit can be inputted to the main unit through any of plural routes. As a result, an information processing apparatus convenient to use can be realized.

What is claimed is:

1. An information processing apparatus comprising a main unit section, and an input device section for receiving an operation input from a user and transmitting information indicating the received operation input to said main unit section,
said main unit section comprising:
a display device;
contact position detecting means provided on a display screen of said display device and detecting a user contact position on said display screen;
receiving means for receiving a signal transmitted from said input device section; and
information processing means for executing processing depending upon the contact position on said display screen detected by said contact position detecting means or in accordance with the signal transmitted from said input device section and received by said receiving means,
said input device section comprising:
a tip portion brought into contact against said display screen for designating a position on said display screen;
first operating means capable of being rotated;
rotation detecting means for detecting a rotating operation applied to said first operating means and outputting a signal representing the rotating operation; and
transmitting means for transmitting the signal from said rotation detecting means to said receiving means of said main unit section.

2. An information processing apparatus according to claim 1, wherein, in said input device section, the rotating operation of said first operating means instructs scrolling of information displayed on said display screen of said display device of said main unit section, and
wherein, in said main unit section, when said receiving means receives the signal representing the rotating operation applied to said first operating means of said input device section, said information processing means scrolls information displayed on said display screen of said display device in accordance with the received signal.

3. An information processing apparatus according to claim 1, wherein, in said input device section, said first operating means is capable of being not only rotated but also depressed;
said input device section further comprises depression detecting means for detecting a depressing operation applied to said first operating means and outputting a signal representing the depressing operation; and
said transmitting means transmits the signal from said depression detecting means.

4. An information processing apparatus according to claim 3, wherein, in said input device section, the rotating operation of said first operating means instructs selection of an optional item displayed on said display screen of said display device of said main unit section; and
when selecting the optional item, the depressing operation of said first operating means of said input device section instructs decision of the selected optional item, and
wherein, in said main unit section, when said receiving means receives the signal representing the rotating operation applied to said first operating means of said input device section, said information processing means selects an optional item displayed on said display screen of said display device in accordance with the received signal; and
when said receiving means receives the signal representing the depressing operation applied to said first operating means of said input device section, said information processing means decides the selected optional item and executes processing corresponding to the decided optional item.

5. An information processing apparatus according to claim 3, wherein said input device section further comprises:
second operating means in addition to said first operating means; and
operation detecting means for detecting an operation applied to said second operating means and outputting a signal representing the applied operation, and
wherein said transmitting means transmits the signal from said operation detecting means.

6. An information processing apparatus according to claim 5, wherein, in said input device section, the rotating operation of said first operating means instructs selection of an optional item in a screen image containing a plurality of optional items and displayed on said display screen of said display device of said main unit section;
the depressing operation of said first operating means of said input device section instructs decision of the selected optional item; and
the operation of said second operating means instructs cancel of a currently displayed screen image, and
wherein, in said main unit section, when said receiving means receives the signal representing the rotating operation applied to said first operating means of said input device section, said information processing means selects an optional item in accordance with the received signal;
when said receiving means receives the signal representing the depressing operation applied to said first operating means of said input device section, said information processing means executes processing designated by the selected optional item; and
when said receiving means receives the signal representing the operation of said second operating means of said input device section, said information processing means cancels a currently displayed screen image in accordance with the received signal.

7. An information processing apparatus according to claim 1, wherein said receiving means of said main unit section and said transmitting means of said input device section are connected to each other through wireless communication.

8. An information processing apparatus according to claim 1, wherein said main unit section further comprises signal generating means for generating an alarm signal, and second transmitting means for transmitting the alarm signal generated by said signal generating means, and
wherein said input device section further comprises second receiving means for receiving the alarm signal transmitted from said second transmitting means, and alarm outputting means for outputting the alarm signal received by said receiving means.

9. An information inputting device for receiving an operation input from a user and supplying a signal representing the received operation input to an information processing main unit, said information inputting device comprising:
a tip portion brought into contact against contact position detecting means, which is provided on a display screen of a display device included in said information processing main unit, for designating a position on said display screen of said display device;
first operating means capable of being rotated;
rotation detecting means for detecting a rotating operation applied to said first operating means and outputting a signal representing the rotating operation; and
transmitting means for transmitting the signal from said rotation detecting means to said information processing main unit.

10. An information inputting device according to claim 9, wherein the rotating operation of said first operating means instructs scrolling of information displayed on said display screen of said display device of said information processing main unit.

11. An information inputting device according to claim 9, wherein said first operating means is capable of being not only rotated but also depressed;
said information inputting device further comprises depression detecting means for detecting a depressing operation applied to said first operating means and outputting a signal representing the depressing operation; and
said transmitting means transmits the signal from said depression detecting means.

12. An information inputting device according to claim 11, wherein the rotating operation of said first operating means instructs selection of an optional item displayed on said display screen of said display device of said information processing main unit; and
when selecting the optional item, the depressing operation of said first operating means instructs decision of the selected optional item.

13. An information inputting device according to claim 11, wherein said information inputting device further comprises:
second operating means in addition to said first operating means; and
operation detecting means for detecting an operation applied to said second operating means and outputting a signal representing the applied operation, and
wherein said transmitting means transmits the signal from said operation detecting means.

14. An information inputting device according to claim 13, wherein the rotating operation of said first operating means instructs selection of an optional item in a screen image containing a plurality of optional items and displayed on said display screen of said display device of said information processing main unit;
the depressing operation of said first operating means instructs decision of the selected optional item; and
the operation of said second operating means instructs cancel of a currently displayed screen image.

15. An information inputting device according to claim 9, wherein said transmitting means transmits a signal to said information processing main unit through wireless communication.

16. An information inputting device according to claim 9, further comprising receiving means for receiving an alarm signal transmitted from said information processing main unit, and alarm outputting means for outputting the alarm signal received by said receiving means.

17. An information processing main unit supplied with a signal from an information inputting device for receiving an operation input from a user and outputting a signal representing the received operation input, said information processing main unit comprising:
a display device;
contact position detecting means provided on a display screen of said display device and detecting a user contact position on said display screen;
receiving means for receiving a signal transmitted from said information inputting device; and
information processing means for executing processing depending upon the contact position on said display screen detected by said contact position detecting means or in accordance with the signal received by said receiving means.

18. An information processing main unit according to claim 17, wherein when said receiving means receives a signal instructing scrolling of information displayed on said display screen of said display device, said information processing means scrolls information displayed on said display screen of said display device in accordance with the received signal.

19. An information processing main unit according to claim 17, wherein when said receiving means receives a signal instructing selection of an optional item displayed on said display screen of said display device, said information processing means selects an optional item displayed on said display screen of said display device in accordance with the received signal; and
when said receiving means receives a signal instructing decision of the selected optional item, said information processing means executes processing corresponding to the selected optional item.

20. An information processing main unit according to claim 17, wherein when said receiving means receives a signal instructing selection of an optional item in a hierarchical selection item image displayed on said display screen of said display device section, said information processing means selects an optional item displayed on said display screen of said display device in accordance with the received signal, and
wherein depending upon a signal instructing decision of the selected optional item and received by said receiving means, said information processing means executes processing designated by the selected optional item when said receiving means receives a signal representing a depressing operation applied to first operating means of said information inputting device; and
said information processing means cancels a currently displayed screen image when said receiving means receives a signal representing an operation of second operating means of said information inputting device.

21. An information processing main unit according to claim 17, wherein said receiving means receives a signal from said information inputting device through wireless communication.

22. An information processing main unit according to claim 17, further comprising signal generating means for generating an alarm signal, and transmitting means for transmitting the alarm signal generated by said signal generating means.
